(19) United States
(12) Patent Application Publication
(10) Pub. No.: US 2019/0339606 A1
(43) Pub. Date: Nov. 7, 2019

(54) DECORATIVE PROJECTION LIGHT ASSEMBLIES, SYSTEMS, AND METHODS

(71) Applicant: Optlaser Technologies Co., LTD, Shenzhen (CN)

(72) Inventors: Wei Yanping, Shenzhen (CN); Sun Linhong, Shenzhen (CN)

(21) Appl. No.: 15/972,422

(22) Filed: May 7, 2018

(51) Int. Cl. G03B 21/20; G03B 23/08

(52) U.S. Cl. CPC G03B 21/2093; G03B 23/08; G03B 21/2033

(57) ABSTRACT

A projection light assembly is provided which achieves a multi-theme animation effect. The assembly includes a main mount board, at least one laser light source coupled to the main mount board, a grating group platform rotatably coupled to the main mount board, at least one grating group mounted to the grating group platform, a motor coupled to the main mount board and/or the grating group platform, and a motherboard in communication with the laser light source, the grating group, and the motor. Light generated by the laser light source is transmitted in a light path and projects through the grating group, and the motor drives the grating group to rotate through the light path. Methods of manufacturing a projection light assembly are also provided. Methods of projecting multi-theme animation include providing at least one grating group containing multiple frames, generating light from a laser light source such that the light is transmitted in a light path projecting through the at least one grating group, and driving the grating group to rotate such that the frames sequentially enter and exit the light path.

### FIELD OF THE DISCLOSURE

The following disclosure relates to decorative projection light assemblies, systems, and methods, including decorative lights and multi-theme animation laser projection light assemblies.

### BACKGROUND

Decorative lights are increasingly popular and are often used to decorate indoor and outdoor spaces of homes and stores. They are used most around holiday times but can be used all year round to create special effects and designs. Today, there are various kinds of decorative lights available, including laser lights, string lights, and character lights.

Currently available decorative lighting devices can create a wide variety of patterns and some can achieve the effect of a moving pattern. However, existing lamps can only achieve the effect of the pattern; they cannot provide an animation effect. Accordingly, there is a need for a decorative projection light that achieve an animation effect. There is also a need for a decorative projection light that can reliably show animation. Finally, there is a need for a decorative projection light that can provide a compact structure and keep manufacturing costs low while achieving multi-theme animation effects.

### SUMMARY

The present disclosure, in its many embodiments, alleviates to a great extent the disadvantages of known decorative projection lights by providing a new projection light assembly that can achieve an animation effect. Disclosed embodiments project the light of the laser transmission through one or more grating groups. A motor controls the rotation of the grating groups so it passes gradually, in turn, through the light path generated by the laser light source. In this way, the theme design gradually changes, creating animation effects. By adjusting the positions of different grating groups using a button or other mechanism the animation themes can be changed. Disclosed projection lights have application in the indoor and outdoor family landscape decoration and holiday lighting market. Disclosed embodiments represent further innovations and transformations of existing laser lamps. Through the design of the program and structure, the output effect of the multi theme animation is achieved through the motor, the laser and the grating groups.

Exemplary embodiments of a projection light assembly comprise a main mount board, at least one laser light source coupled to the main mount board, a grating group platform rotatably coupled to the main mount board, at least one grating group mounted to the grating group platform, a motor coupled to the main mount board and/or the grating group platform, and a motherboard in communication with the laser light source, the grating group, and the motor. Light is generated by the laser light source and transmitted in a light path which projects through the grating group, and the motor drives the grating group to rotate through the light path.

In exemplary embodiments, the at least one grating group contains multiple frames, and each frame may contain a different animation pattern representing a different action or change in theme. In exemplary embodiments, the motor drives the grating group to rotate back and forth such that the frames sequentially enter and exit the light path. The projection light assembly may further comprise a switch to reset the grating group platform and return the grating group platform to its initial position. In exemplary embodiments, the main mount board has at least one stop pile and the grating group platform has at least one stop piece, and when rotation of the grating group platform causes the stop piece to contact the stop pile, the grating group platform resets and returns to its initial position.

In exemplary embodiments, the at least one grating group is in the form of an arc. In other embodiments, the at least one grating group is in the form of a helix. The at least one grating group may comprise at least two different grating groups, and each grating group corresponds to a different theme. The motor may drive the grating groups to rotate such that the different grating groups enter and exit the light path so the different themes are displayed. In exemplary embodiments, two or more grating groups are configured in a hexagonal arrangement or a circular arrangement, and the motor has an axis located in the middle of the arrangement of grating groups.

The grating groups may be manually replaceable. In exemplary embodiments, the at least one grating group is not moved, and the laser source scans the grating group to create an animation effect. In exemplary embodiments, there are at least two different themes, each theme having one or more frames, and the frames are arranged in a helix. The grating group platform may have a vertical screw structure, and the motor may drive the screw structure to move up and down to rotate the different frames such that the different frames enter and exit the light path so the different themes are displayed.

Exemplary methods of projecting multi-theme animation comprise providing at least one grating group containing multiple frames where each frame contains a different pattern, generating light from a laser light source such that the light is transmitted in a light path projecting through the at least one grating group, and driving the grating group to rotate such that the frames sequentially enter and exit the light path. In exemplary embodiments, the at least one grating group comprises at least two different grating groups, each grating group corresponding to a different theme. When the different grating groups enter and exit the light path the different themes are displayed. Exemplary methods may further comprise resetting the at least one grating group and returning the at least one grating group to its initial position.

Exemplary methods comprise providing at least two different grating groups, each grating group corresponding to a different theme, and arranging the grating groups in a hexagonal arrangement or a circular arrangement. Exemplary methods comprise providing at least two different themes, each theme having one or more frames, and arranging the frames in a helix. A vertical screw structure may be provided. Exemplary methods include driving the screw structure so it moves up and down to rotate the different frames such that the different frames enter and exit the light path so the different themes are displayed.

Exemplary methods of manufacturing a projection light assembly comprise coupling at least one laser light source to a main mount board, rotatably coupling a grating group platform to the main mount board, mounting at least one grating group to the grating group platform such that light generated by the laser light source and transmitted in a light path projects through the grating group, coupling a motor to the main mount board and/or the grating group platform, the motor driving the grating group to rotate through the light path, and communicatively connecting a motherboard with the laser light source, the grating group, and the motor. Exemplary methods may further comprise connecting at least one stop pile to the main mount board and at least one stop piece to the grating group platform. When rotation of the grating group platform causes the stop piece to contact the stop pile, the grating group platform resets and returns to its initial position. Exemplary methods may further comprise providing a switch to reset the grating group platform and return the grating group platform to its initial position.

Accordingly, it is seen that decorative projection light assemblies, systems, and methods are provided which create animation effects. Disclosed embodiments advantageously provide a compact structure and keep manufacturing costs relatively low while achieving multi-theme animation effects. These and other features and advantages will be appreciated from review of the following detailed description, along with the accompanying figures in which like reference numbers refer to like parts throughout.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a perspective view of an exemplary embodiment of a projection light assembly in accordance with the present disclosure;

FIG. 2 is a perspective and detail view of an exemplary embodiment of a projection light assembly in accordance with the present disclosure;

FIG. 3 is an exploded view of an exemplary embodiment of a projection light assembly in accordance with the present disclosure;

FIG. 4 is a perspective view of an exemplary embodiment of a projection light assembly in accordance with the present disclosure;

FIG. 5 is a perspective view of an exemplary embodiment of a projection light assembly in accordance with the present disclosure;

FIG. 6 is a perspective view of an exemplary embodiment of a projection light assembly in accordance with the present disclosure;

FIG. 7 is a perspective view of an exemplary embodiment of a projection light assembly in accordance with the present disclosure;

FIG. 8A is a perspective view of an exemplary embodiment of a projection light assembly in accordance with the present disclosure;

FIG. 8B is a perspective and detail view of the projection light assembly of FIG. 8A;

FIG. 8C is an exploded view of the projection light assembly of FIG. 8A;

FIG. 9 is a perspective view of an exemplary embodiment of a projection light assembly in accordance with the present disclosure;

FIG. 10 is a perspective view of an exemplary embodiment of a projection light assembly in accordance with the present disclosure;

FIG. 11 is a perspective view of an exemplary embodiment of a projection light assembly in accordance with the present disclosure;

FIG. 12 is a perspective view of an exemplary helical arrangement and vertical screw structure in accordance with the present disclosure;

FIG. 13 is a perspective view of an exemplary embodiment of a projection light assembly in accordance with the present disclosure;

FIG. 14 is a perspective view of an exemplary embodiment of a projection light assembly in accordance with the present disclosure;

FIG. 15 is a perspective view of an exemplary embodiment of a system and method of projecting multi-theme animation in accordance with the present disclosure;

FIG. 16 is a perspective view of an exemplary embodiment of a system and method of projecting multi-theme animation in accordance with the present disclosure;

FIG. 17 is a perspective view of an exemplary embodiment of a system and method of projecting multi-theme animation in accordance with the present disclosure;

FIG. 18 is a perspective view of an exemplary embodiment of a projection light assembly in accordance with the present disclosure;

FIG. 19 is a perspective view of an exemplary embodiment of a projection light assembly in accordance with the present disclosure; and

FIG. 20 is a perspective view of an exemplary embodiment of a system and method of projecting multi-theme animation in accordance with the present disclosure.

### DETAILED DESCRIPTION

In the following detailed description of exemplary embodiments of the disclosure, reference is made to the accompanying drawings in which like references indicate similar elements, and in which is shown by way of illustration specific embodiments in which disclosed systems and devices may be practiced. These embodiments are described in sufficient detail to enable those skilled in the art to practice the embodiments, and it is to be understood that other embodiments may be utilized and that logical, mechanical, functional, and other changes may be made without departing from the scope of the present disclosure. The following detailed description is, therefore, not to be taken in a limiting sense, and the scope of the present disclosure is defined by the appended claims. As used in the present disclosure, the term “or” shall be understood to be defined as a logical disjunction and shall not indicate an exclusive disjunction.

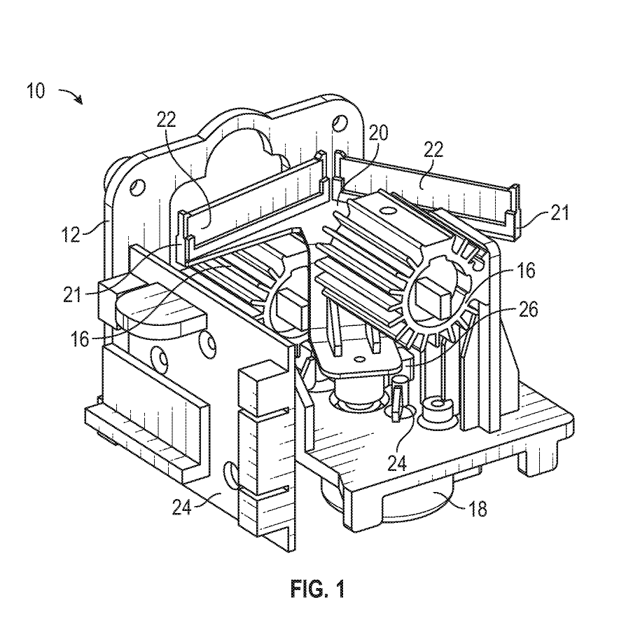

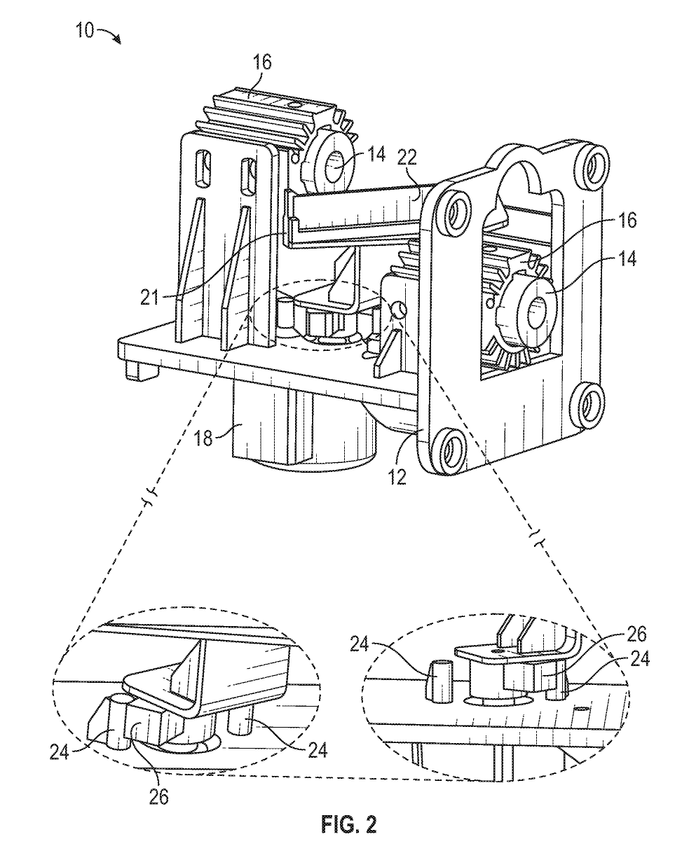

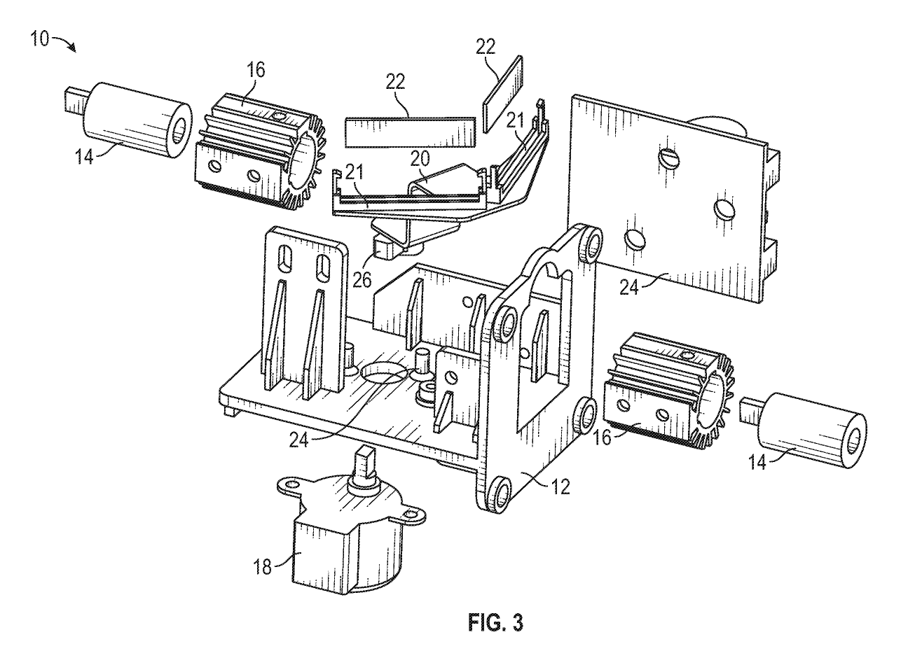

FIGS. 1-4 illustrate exemplary embodiments of a projection light assembly. Projection light assembly 10 comprises a main mount board 12 which has a number of components attached or coupled to it. At least one laser light source 14 is coupled to the main mount board 12. Any number of laser light sources could be used in a variety of colors including but not limited to red, green, blue, and white. Exemplary embodiments include a laser module mount 16 to facilitate connection of the laser light source 14. More particularly, laser light source 14 is connected to the laser module mount 16, which, in turn, is coupled to the main mount board 12, thereby mounting the laser light source 14.

One or more motors 18 may be provided and attached to the main mount board 12. In exemplary embodiments, motor 18 is located below the main mount board 12 and may be connected to a bottom surface of the main mount board and/or partially penetrating through an aperture in the bottom surface of the main mount board. It should be noted, however, that the motor 18 could be in various locations depending on the application and desired movement of the other components of the projection light assembly 10. A motherboard (or PCB or PCBA board) 24 is provided and is in communication with the laser light source 14, the motor 18, and one or more grating groups 22.

In exemplary embodiments, a grating group platform or disk 20 is coupled to the main mount board 12, and at least one grating group 22 mounted to the grating group platform 20. The grating group 22 and grating group platform 20 are configured and located so the grating group 22 is generally in the path of light projected by the laser light source 14. More particularly, when light is generated by the laser light source 14, it is transmitted in a light path 15 that projects through the grating group 22. A grating group mount 21 may be attached to or integrally formed with the grating group platform 20 and the grating group or groups attached to the grating group disk in various configurations described in more detail herein.

In exemplary embodiments, the grating group platform 20 is rotatably coupled to the main mount board 12 so the grating group 22 can be rotated back and forth in the light path 15. A stop pile 24 may be formed on or attached to a surface of the main mount board 12, a corresponding stop piece 26 formed on or attached to the grating group platform 20. As described in more detail herein, contact between the stop pile 24 and stop piece 26 stops rotation of the grating group platform 20 and grating group 22 and may reset the movement path. As described in more detail herein, a switch may be provided to reset the grating group platform 20 and return it to its initial position.

In exemplary embodiments, the grating group 22 is in the form of a long straight or curved strip and contains a number of different patterns. As best seen in FIGS. 5 and 7, a grating group 22 may be comprised of multiple frames 28, where each frame is an individual pattern of a theme or story and together the frames 28 of a grating group 22 make up a whole theme or story. The concept is similar to that of paper animation frames or reels of film. As discussed in more detail herein, in various embodiments, the grating group or groups may be in the form of an arc or helix.

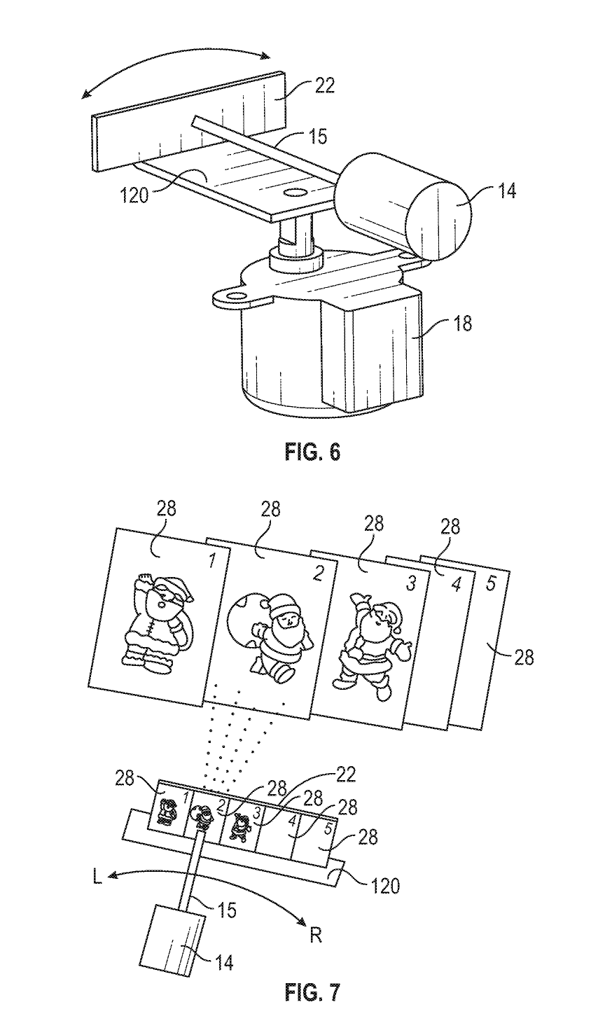

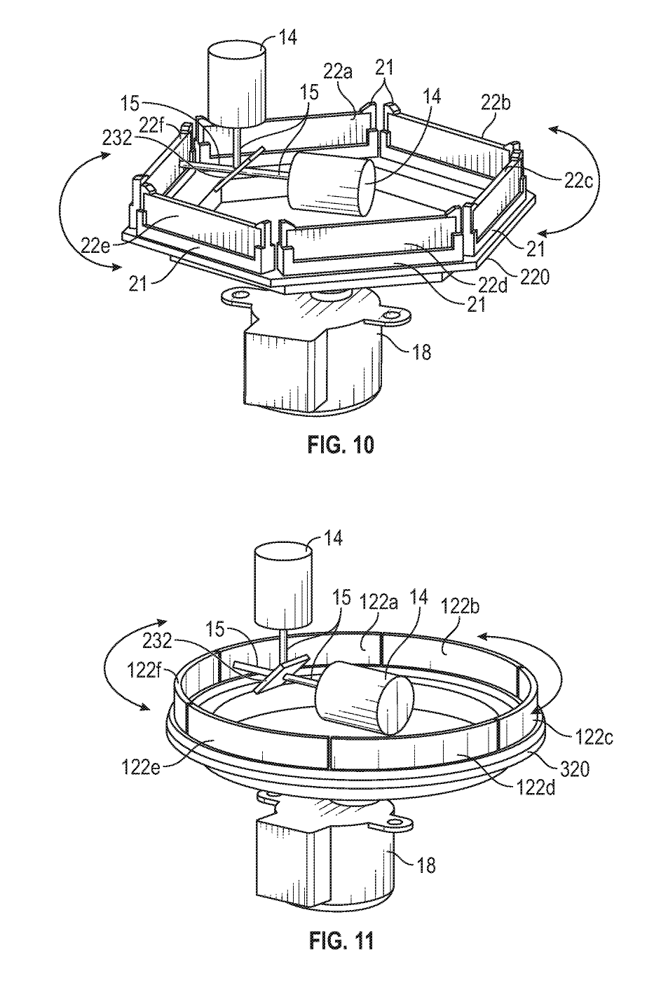

Turning to FIGS. 6-12, exemplary embodiments of projection light assembly having different numbers of grating groups will be described. An exemplary projection light assembly which has one grating group 22 is illustrated in FIGS. 6 and 7. The laser light source 14 projects and transmits a light path 15 through the grating group 22 as the motor drives the grating group platform 120 to rotate back and forth to display the different frames 28 of the grating group 22. The grating group platform 120 has a substantially flat surface suitable for mounting the grating group 22. In exemplary embodiments, grating group platform 120 is square or rectangular and has grating group 22 mounted at a distal edge opposite the location of the laser light source 14. The grating group 22 could sit directly on the grating group platform 120 or could be mounted in a grating group mount 21. In exemplary embodiments, the grating groups are manually replaceable.

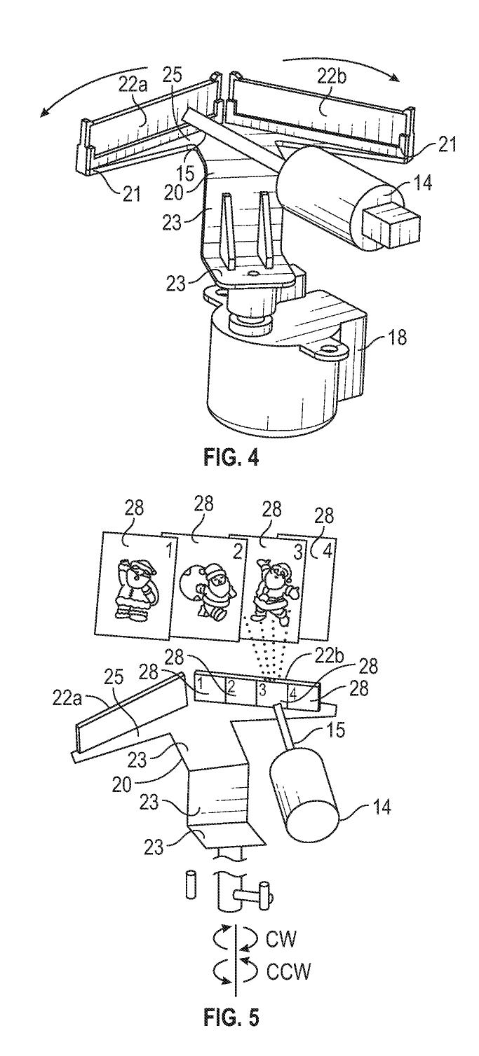

As best seen in FIGS. 4 and 5, two different grating groups 22 may be provided where each grating group corresponds to a different theme. Grating group platform 21 designed to support two grating groups 22a, 22b. In exemplary embodiments, grating group platform 20 comprises stepped sections 23 and a triangular shaped flat section 25 with space to mount two grating groups 22a, 22b. It should be noted that the grating group platform, and the flat section in particular, could take different forms and shapes such as a semi-circle, a T-shape, or any other shape suitable for mounting two grating groups. The grating groups 22 could sit directly on the flat section 25 of the grating group platform 20 or could be mounted in grating group mounts 21. The motor 18 drives the grating groups 22 so they rotate. More particularly, the grating groups 22 rotate so that the two different grating groups 22a, 22b enter and exit the light path 15, thereby displaying in turn first the theme contained in the frames of first grating group 22a and then the theme contained in frames of the second grating group 22b. This configuration can be used with up to five grating groups.

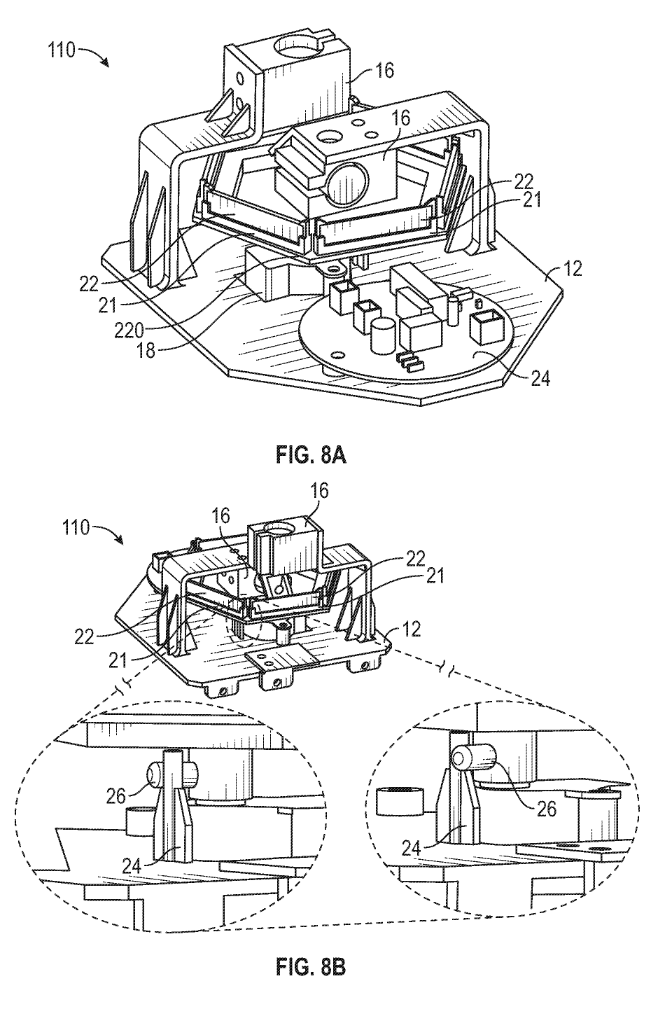

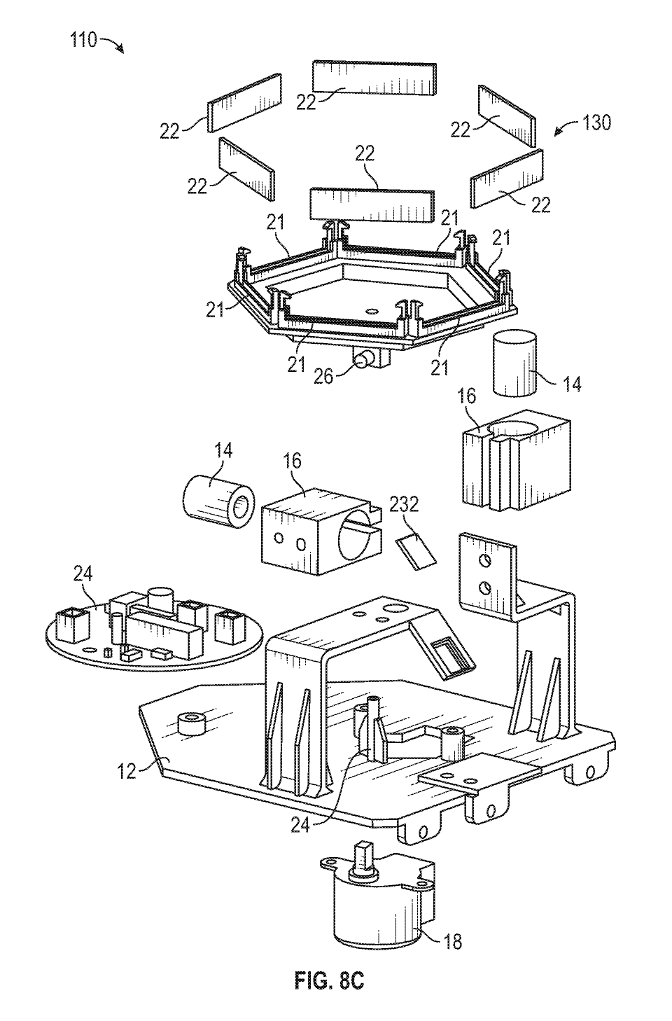

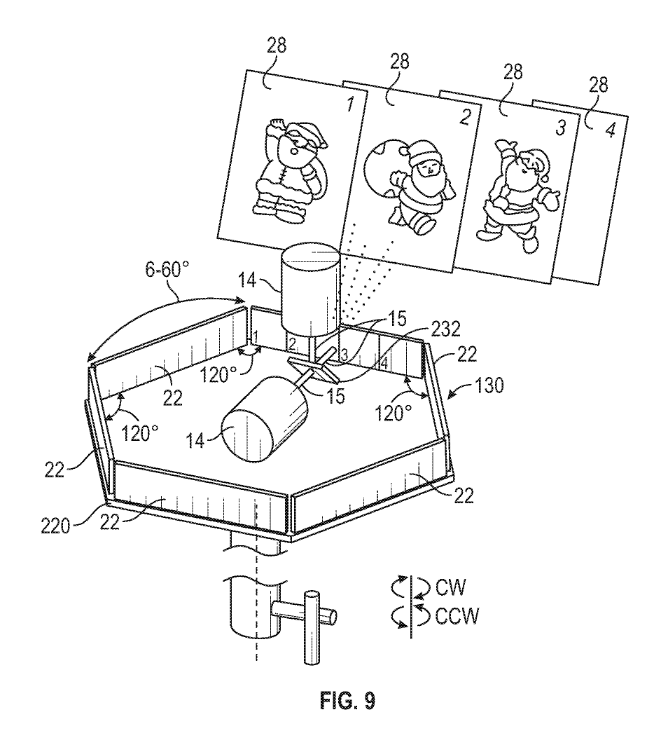

In exemplary embodiments, two or more different grating groups are provided and configured in a hexagonal or circular arrangement. As shown in FIGS. 8A-11, exemplary projection light assemblies 110 have six different grating groups 22, each corresponding to a different theme or story. In such embodiments, the number of grating groups and frames is large enough to be completely surrounded. Thus, the optimal configuration for six grating groups is either a hexagonal arrangement 130 or a circular arrangement 132 with the laser light source 14 is located in the center surrounded by the six grating groups 22a-22f, 122a-122f. As best seen in FIG. 9, the angle between each two grating groups is 120 degrees, so the assembly forms six grating groups 22a-22f situated on the edges of the hexagonal grating group disk 220.

An exemplary circular arrangement can be seen in FIG. 11, wherein six curved grating groups 122a-122f surround the laser light source 14. The axis of the motor 18 is located in the middle of the circular grating group disk 320, so the motor can drive the grating group platform or disk 320 so the laser light path 15 passes through the arrangement of grating groups 122a-122f. As best seen in FIGS. 9-11, exemplary embodiments include a reflector 232 coupled to motor 18. Reflector 232 enables light paths 15 from two different laser light sources 14 to be transmitted from the laser light sources 14 through the grating groups 22a-22f, 122a-122f.

Turning to FIG. 12, exemplary embodiments of projection light assemblies having seven or more themes will now be described. When the theme pattern needs more than six different themes, using grating groups may not be feasible. In these instances, the structure of the projection light assembly is changed so the frames are not placed on a plane. Rather, the grating group platform 420 has a vertical screw structure 413. Multiple themes or stories, where each may include one or more frames, are arranged in a helix 415 encircling the main mount board. In other words, the grating group itself is made into helical or spiral structure. The motor 18 drives the screw structure 413 to move up and down to rotate the different frames of the helix so they enter and exit the light path 15 so the different themes are displayed. The screw structure 413 can be made to rotate and move up and down at the same time by motor rotation, thereby achieving the theme effect by control of the motor 18. In exemplary embodiments, a second laser light source is added, and one laser is used for the background, the other used for the theme. This prevents the pattern from becoming monotonous.

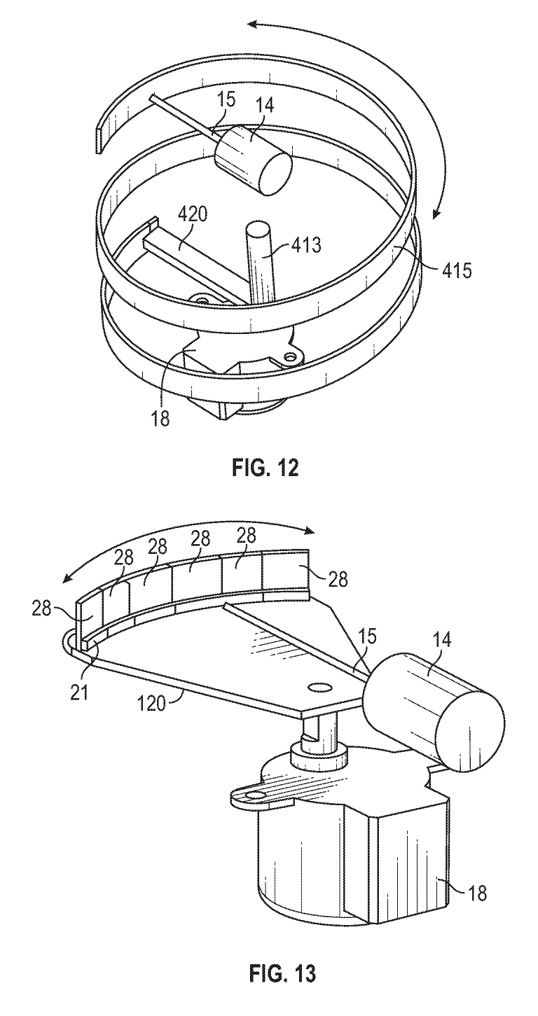

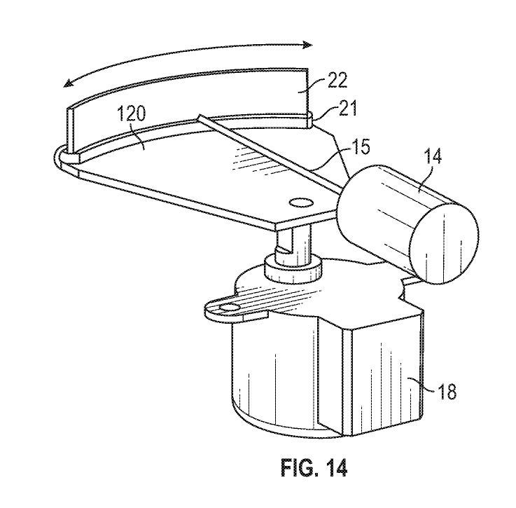

FIGS. 13-14 illustrate exemplary embodiments in which a grating group 22, individual grating units or frames 28 are arranged in a semi-circle. As best seen in FIG. 13, single grating units or frames 28 may be composed of grating groups 22 where the grating group structure is approximately a circular arc. In FIG. 14, it can be seen that the single grating group 22 is made of a circular arc. The center of the circle is located at the point of emission of the laser light source 14. It is should be noted that the closer the grating structure is with the circle, the lower the deformability.

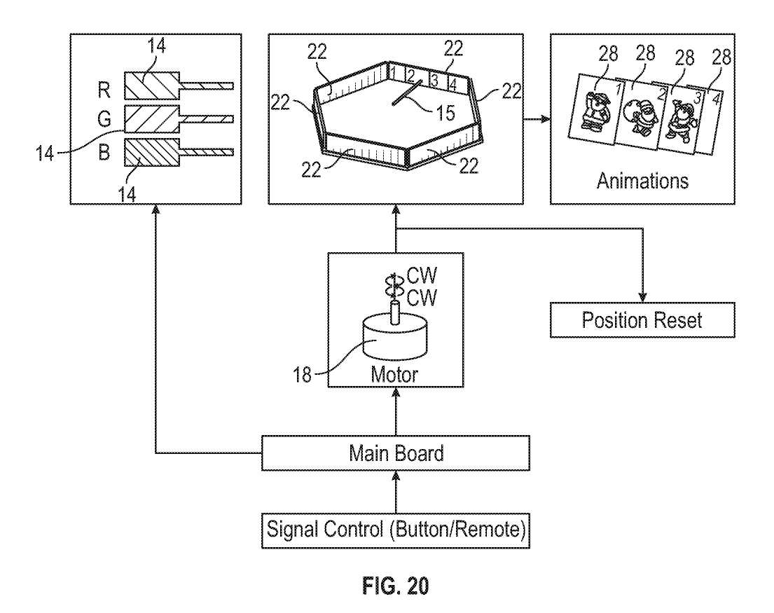

In operation, exemplary projection light systems and methods create multi-theme animation effects by the following general steps, illustrated in FIG. 20. They provide at least one grating group 22 which contains multiple frames 28, and each frame contains a different pattern. As illustrated in FIGS. 5, 7, 9, and 15. light is generated from a laser light source 14 and is transmitted in a light path 15 projecting through the grating group 22. The grating group 22 is driven to rotate so the frames 28 sequentially enter and exit the light path 15. More particularly, a motor 18 drives the grating group or groups 22 to rotate back and forth, so that the light from the laser light source 14 is swept from the first frame to the N frame, and then the N frame is swept to the first frame. This cycle can display different patterns of a theme and create animation effect. In exemplary embodiments, the grating group or groups 22 are mounted on a grating group platform or disk 20, and the motor 18 drives the platform or disk 20 to rotate through the light path 15.

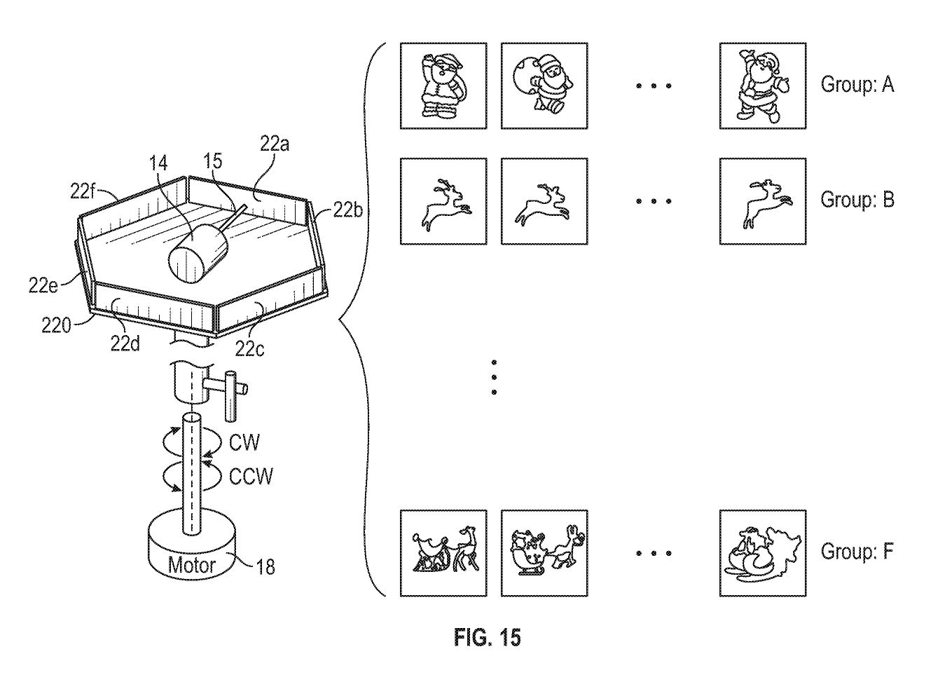

As discussed above, the number of grating groups could range from one to almost any number. Likewise, the number of frames could vary considerably. The number of grating groups or frames needed might depend on the length or complexity of the themes or stories being conveyed. As the number of topics increases, the structure design needs to make corresponding improvements. As best seen in FIG. 15, exemplary methods of creating multi-theme animation effects using multiple grating groups 22a-22f include arranging the grating groups in a hexagonal arrangement or a circular arrangement and projecting the light path 15 through the grating groups 22a-22f sequentially through groups or themes A-F. As discussed above, when the theme or story requires seven or more grating groups 22, they may be arranged in a spiral or helix configuration 415 and a vertical screw structure 413 is provided. The screw structure 413 is driven to move up and down to rotate the different frames of the helix 415 so they enter and exit the light path 15 so the different themes are displayed.

In exemplary embodiments, methods of resetting a projection light assembly and switching themes or stories are provided. These could include resetting and starting the same theme again or switching to a new theme and starting the new theme. When the animation lights are activated and switched to the theme of animation, a reset action may be required. An exemplary reset method comprises resetting at least one grating group 22 and returning it to its initial position. The method may utilize a stop mechanism, as described above, in which there is a stop pile 24 on a surface of the main mount board 12 and a corresponding stop piece 26 on the grating group platform 20. When the stop piece 26 is contacted by the stop pile 24, they stop rotation of grating group platform 20 and the rotary mechanism returns to the initial position to complete the reset. Exemplary mechanical stop reset methods can also use a Holzer switch or a position switch to transmit the reset position to a single chip computer on the motherboard 24 to achieve the same purpose. When reset, the main circuit control motor may rotate against the clock. These methods can also be used to achieve a switch from one theme or story to another theme or story.

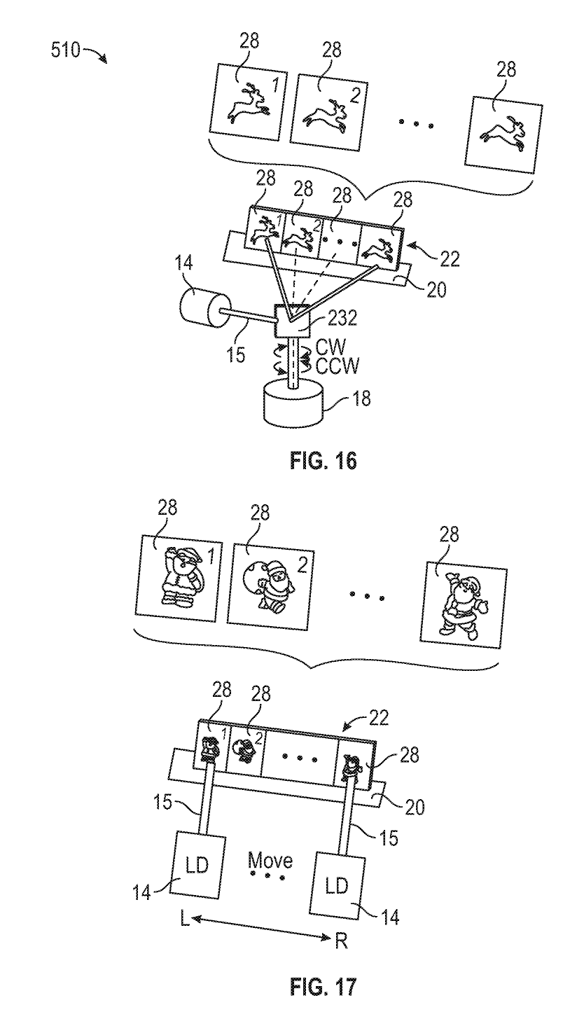

Turning to FIGS. 16-19, exemplary methods of providing multi-theme animation effects without moving grating groups will now be described. As shown in FIG. 16, projection light assembly 510 includes a reflector 232 coupled to motor 18. The laser light source 14 and grating group 22 are fixed in position and are not moved. Rather, the reflector 232 is shifted or its angle changed so the light path 15 transmitted from the laser light source 14 scans the grating group 22. In another method, illustrated in FIG. 17, the laser light source module 14 itself could be shifted or the angle of the module rotated so the light path 15 transmitted from the laser light source 14 scans the grating group 22.

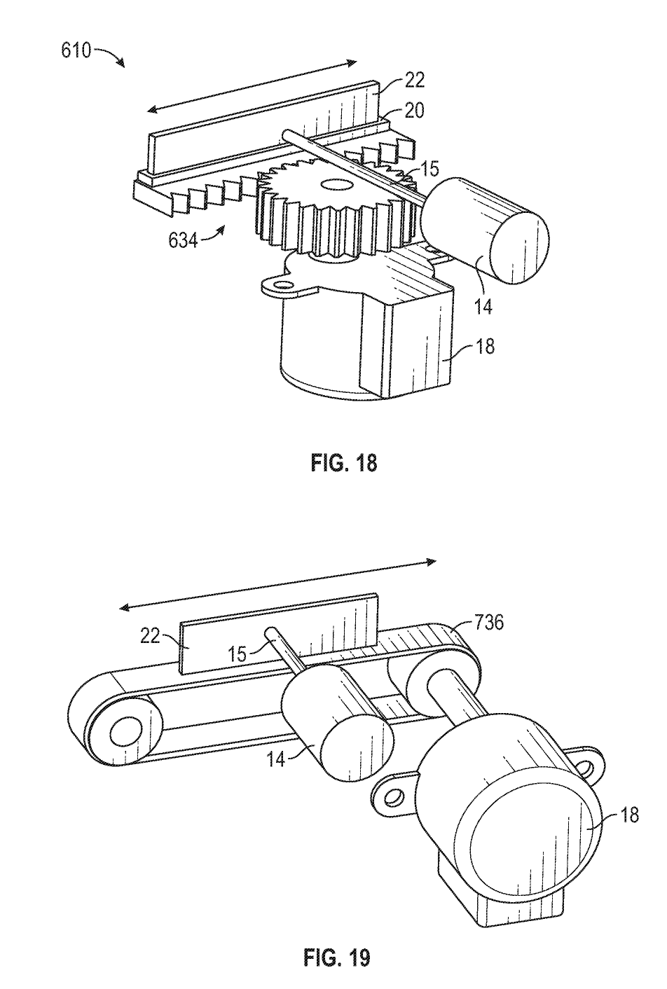

FIG. 18 illustrates a projection light assembly 610 in which motor 18 drives a rack or belt 634 to make the grating group 22 move in a straight line. Due to the limited size of the light body, this method does not support the long size grating group and would be used for fewer grating groups only, and typically a single grating group. In this method, the grating group would not be changed. In another embodiment of a projection light assembly 710, shown in FIG. 19, motor 18 drives a rack to move back and forth so that the laser light source 14 can evenly sweep all the patterns of the grating group 22. The rack can also be replaced by a belt 736 and the motor 18 would drive one of the wheels to turn back and forth. This method also would be used for fewer grating groups only, and typically a single grating group.

Exemplary methods of manufacturing projection lighting assemblies having multi-theme animation capability are also provided. A method of manufacturing a projection light assembly 10, 110, 510, 610, 710 comprises coupling a laser light source 14 to a main mount board 12. A grating group platform 20 is also coupled to the main mount board 12. In exemplary embodiments, the grating group platform 20 is connected so it can rotate relative to the main mount board 12. One or more grating groups 22 are mounted to the grating group platform 20, either directly or via one or more grating group mounts 21. The grating groups 22 are positioned so a light path 15 transmitted by the laser light source 14 projects through them. A motor 18 is coupled to the main mount board 12 and/or to the grating group platform 20 so it can drive the grating group or groups 22 to rotate through the light path 15.

A motherboard 24 is connected so it can electronically communicate with one or more of the other components of the projection light assembly including, but not limited to, the laser light source 14, the grating group platform 20, and the motor 18. At least one stop pile 24 is connected to or integrally formed with the main mount board 12. At least one corresponding one stop piece 26 is connected to or integrally formed with the grating group platform 20. The stop pile 24 and stop piece are position so that rotation of the grating group platform 20 causes the stop piece 26 to contact the stop pile 24. When this occurs, the grating group platform 20 resets and returns to its initial position.

While the disclosed systems and devices have been described in terms of what are presently considered to be the most practical exemplary embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

Thus, it is seen that improved projection light assembly, systems, and methods are provided. It should be understood that any of the foregoing configurations and specialized components or chemical compounds may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

1. A projection light assembly comprising:
a main mount board;
at least one laser light source coupled to the main mount board;
a grating group platform rotatably coupled to the main mount board;
at least one grating group mounted to the grating group platform such that light generated by the laser light source and transmitted in a light path projects through the grating group;
a motor coupled to one or both of: the main mount board and the grating group platform; and
a motherboard in communication with the laser light source, the grating group, and the motor.

2. The projection light assembly of claim 1 wherein the motor drives the grating group to rotate through the light path.

3. The projection light assembly of claim 1 wherein the at least one grating group is not moved, and the laser source scans the grating group to create an animation effect.

4. The projection light assembly of claim 1 wherein the at least one grating group contains multiple frames.

5. The projection light assembly of claim 4 wherein each frame contains a different animation pattern representing a different action or change in theme.

6. The projection light assembly of claim 4 wherein the motor drives the grating group to rotate back and forth such that the frames sequentially enter and exit the light path.

7. The projection light assembly of claim 1 wherein the main mount board has at least one stop pile and the grating group platform has at least one stop piece.

8. The projection light assembly of claim 7 wherein when rotation of the grating group platform causes the stop piece to contact the stop pile, the grating group platform resets and returns to its initial position.

9. The projection light assembly of claim 1 further comprising a switch to reset the grating group platform and return the grating group platform to its initial position.

10. The projection light assembly of claim 1 wherein the at least one grating group is in the form of an arc or a helix.

11. The projection light assembly of claim 1 wherein the at least one grating group comprises at least two different grating groups, each grating group corresponding to a different theme; and
wherein the motor drives the grating groups to rotate such that the different grating groups enter and exit the light path so the different themes are displayed.

12. The projection light assembly of claim 1 wherein the at least one grating group comprises at least two different grating groups, each grating group corresponding to a different theme;
wherein the grating groups are configured in one of: a hexagonal arrangement or a circular arrangement; and
wherein the motor has an axis located in the middle of the arrangement of grating groups.

13. The projection light assembly of claim 1 wherein the grating groups are manually replaceable.

14. The projection light assembly of claim 1 wherein the at least one grating group comprises at least two different themes, each theme having one or more frames;
wherein the frames are arranged in a helix;
wherein the grating group platform has a vertical screw structure; and
wherein the motor drives the screw structure move up and down to rotate the different frames such that the different frames enter and exit the light path so the different themes are displayed.

15. A method of projecting multi-theme animation, comprising:
providing at least one grating group containing multiple frames, each frame containing a different pattern;
generating light from a laser light source such that the light is transmitted in a light path projecting through the at least one grating group; and
driving the grating group to rotate such that the frames sequentially enter and exit the light path.

16. The method of claim 15 wherein the at least one grating group comprises at least two different grating groups, each grating group corresponding to a different theme; and
wherein when the different grating groups enter and exit the light path the different themes are displayed.

17. The method of claim 15 further comprising resetting the at least one grating group and returning the at least one grating group to its initial position.

18. The method of claim 15 wherein the at least one grating group comprises at least two different grating groups, each grating group corresponding to a different theme, and further comprising:
arranging the grating groups in one of: a hexagonal arrangement or a circular arrangement.

19. The method of claim 15 wherein the at least one grating group comprises at least seven different themes, each theme having one or more frames, and further comprising
arranging the frames in a helix;
providing a grating group platform having a vertical screw structure; and
driving the screw structure so it moves up and down to rotate the different grating groups such that the different grating groups enter and exit the light path so the different themes are displayed.

20. A method of manufacturing a projection light assembly, comprising:
coupling at least one laser light source to a main mount board;
rotatably coupling a grating group platform to the main mount board;
mounting at least one grating group to the grating group platform such that light generated by the laser light source and transmitted in a light path projects through the grating group;
coupling a motor to one or both of the main mount board and the grating group platform, the motor driving the grating group to rotate through the light path; and
communicatively connecting a motherboard with the laser light source, the grating group, and the motor.

21. The method of claim 18 further comprising connecting at least one stop pile to the main mount board and connecting at least one stop piece to the grating group platform;
wherein when rotation of the grating group platform causes the stop piece to contact the stop pile, the grating group platform resets and returns to its initial position.
